(19) United States
(12) Patent Application Publication
(10) Pub. No.: US 2010/0303214 A1
(43) Pub. Date: Dec. 2, 2010

(54) ONE-WAY VOICE DETECTION VOICEMAIL

(75) Inventors: Stuart O. Goldman, Scottsdale, AZ (US); Anil P. Macwan, Naperville, IL (US); Karl F. Rauscher, Emmaus, PA (US); RIchard E. Krock, Naperville, IL (US)

Correspondence Address: HITT GAINES, PC;ALCATEL-LUCENT, PO BOX 832570, RICHARDSON, TX, 75083, US

(73) Assignee: Alcatel-Lucent USA, Incorportaed, Murray Hill, NJ (US)

(21) Appl. No.: 12/476,225

(22) Filed: Jun. 1, 2009

(51) Int. Cl. H04M 1/64

(52) U.S. Cl. 379/88.01

(57) ABSTRACT

A telephone answering system includes a receiver, a detector and a transmitter. The receiver is configured to receive a voice signal. The detector is adapted to detect voice activity on the signal. The transmitter is adapted to transmit an initial prompt. In the event that the detector detects a gap in the voice activity after the initial prompt, transmitter is configured to transmit a notice.

### TECHNICAL FIELD

This application is directed, in general, to telephony and, more specifically, to a message recording system.

### BACKGROUND

In traditional telephony a voice path, or channel, from the caller to a central office was “validated” with a caller being able to hear a dial tone and a central office being able to “hear” DTMF digits entered by the caller. A trunking path connecting the central office to intermediate offices and then to a terminating central office, was “validated” by the successful transmission and reception of the tones over the voice path.

When signaling system 7 (SS7) was introduced, the voice path was no longer automatically validated for each call, as the signaling needed for call set-up was now sent over a control channel rather than the voice channel. The absence of such validation was resolved in two ways. In a first option, a continuity test was performed. A tone was sent in the forward direction, detected at the far end, and a complementary tone was returned. Thus the speech path trunk was tested in both directions. The continuity test occurred either on every call or on a sample of calls. The second option was known as the detection of a “killer trunk.” Service providers gathered statistics on a number of calls and holding times on those calls. A killer trunk had an abnormally large number of calls and very short holding times. This pattern was attributed to the inability to maintain a conversation. Such an inability would indicate the occurrence of one-way speech, no speech, or very noisy connections.

### SUMMARY

One aspect provides a telephone answering system. The system includes a receiver, a detector and a transmitter. The receiver is configured to receive a voice signal. The detector is adapted to detect voice activity on the signal. The transmitter is adapted to transmit an initial prompt. The transmitter is configured to transmit a notice in the event that the detector detects a gap in the detected voice activity after the initial prompt.

Another aspect provides a method of telephone communication. The method begins by transmitting an initial prompt. Voice activity on a voice channel is determined. A notice is transmitted in the event that a gap in said voice activity is detected after said initial prompt.

Another aspect provides a calling system that includes a controller, a receiver and a tone detector. The controller is configured to place a telephone call. The receiver is configured to receive a transmit path failure tone in response to the call. The detector provides an alert in response to the tone.

### BRIEF DESCRIPTION

Reference is now made to the following descriptions taken in conjunction with the accompanying drawings, in which:

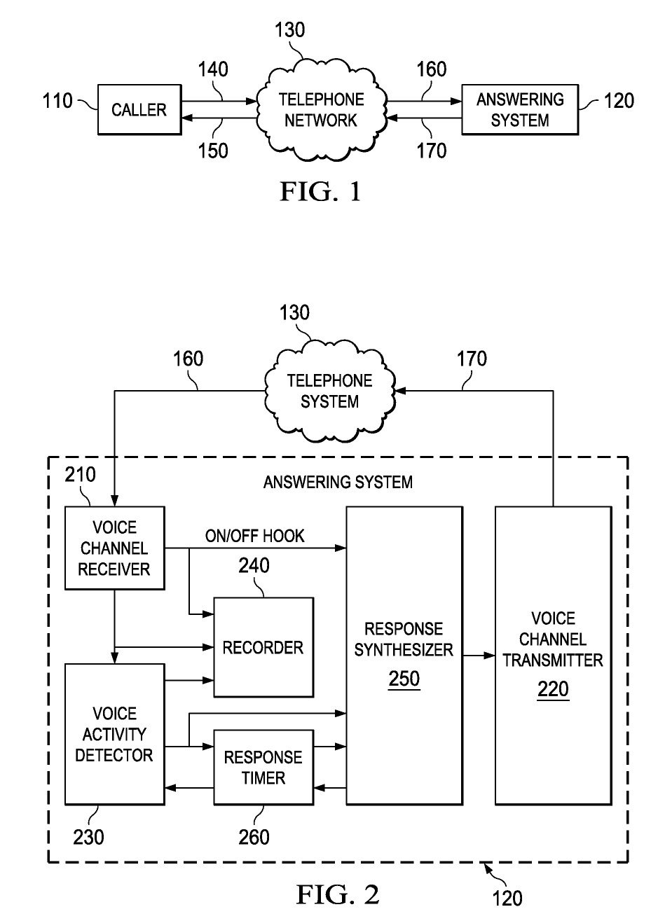

FIG. 1 illustrates communication via a telephone system;

FIG. 2 illustrates an example embodiment of a voice communication system;

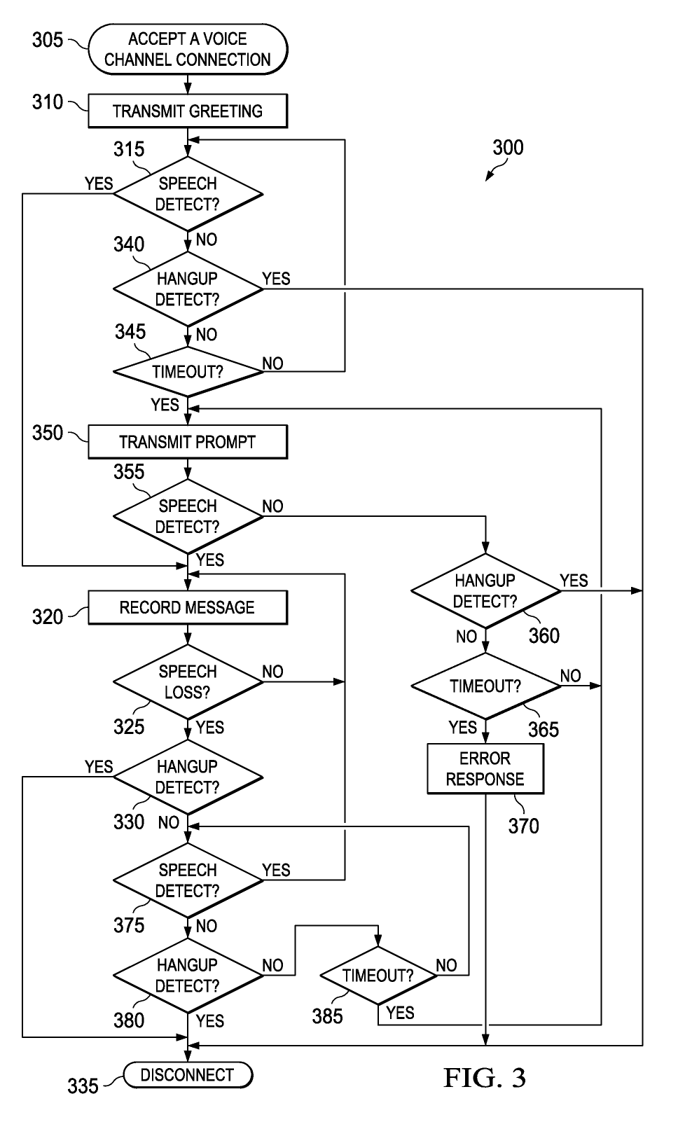

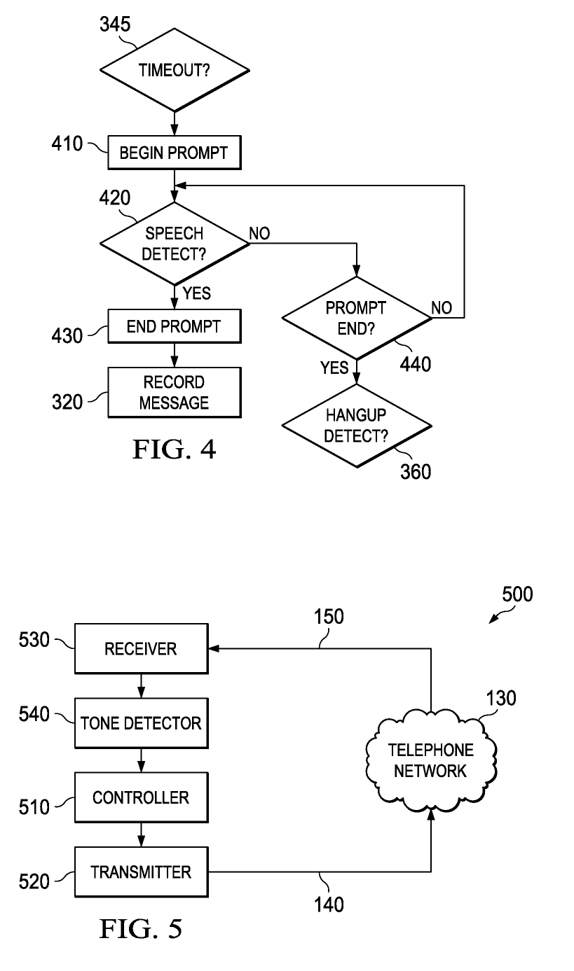

FIGS. 3 and 4 illustrate example embodiments of a method; and

FIG. 5 illustrates a calling system.

### DETAILED DESCRIPTION

When a caller places a call over a wireless or an IP (internet protocol)-based connection, the caller typically does not know that he/she is being heard, unless a receiving entity provides a feedback response. For example, a wireless or IP communication path may only be conducting speech in one direction, or a wireless telephone call may experience a dropout. In the present context, a “wireless connection” is a connection that relies on one or more free-space paths over which radio-frequency energy carries telephonic communication. In some cases, such as cellular network calls, there may be a brief period during a handover from one network cell to another during which during which speech may be lost as the user handset changes channels. Similar dropout can occur in an IP (internet) network with router buffer overflow.

When the receiving entity is a person, absence of a response from that person alerts the caller to a lost voice path. However, conventional message recording systems, e.g., answering machines and voice mail systems, typically do not include a mechanism to validate the speech path for wireless and IP based calls that terminate at the answering system. Typically, the answering system simply disconnects after a period of time after losing the incoming voice channel without providing any indication of the disconnection to the caller. The caller may hang up, believing he left a message, before the recording system times out and disconnects. Thus, there is a need for a mechanism to validate the speech path for wireless and IP based calls terminating at a user's answering machine or a voice mail system.

Embodiments herein describe a system and a method for validating a speech path from a caller to a message recording system with which the caller is in telephonic communication. The recording system may provide aural feedback to the caller in the event that no voice communication is detected by the recorder. In such an event, the caller may, e.g., disconnect and make another attempt to connect to the recorder.

FIG. 1 illustrates a system according to one embodiment of the disclosure. A caller 110 communicates with a message recording system 120 via a telephone network 130. The network 130 may include, e.g., one or more of a plain-old telephone system (POTS), fiber-optic, internet, terrestrial wireless, and satellite communication links, or any other type of telephone network technology. The system 120 may be, e.g., a voice mail system or a home answering system. A voice mail system may include system components located at a user location (e.g., a business office environment) or a telephone service provider location.

The caller 110 connects to the network 130 by any means, such as, e.g., a wired handset, a mobile handset, an IP telephone, or a computer application (e.g., Skype™). A full connection includes a transmit path 140 between the caller 110 and the network 130, and a receive path 150 between the network 130 and the caller 110. The system 120 may be connected to the network 130 by any access device or system. Often, such a connection will include a wired connection to a local wired sub-network, but the connection may also be a wireless access. A complete connection between the network 130 and the system 120 includes a receive path 160 and a transmit path 170.

The paths 140, 150, 160 170 may be physically separate paths or may share a communications medium. Thus, e.g., the paths 160, 170 may be along physically distinct wires, an RF link or a TCP/IP data path. The paths are shown separately for discussion purposes, but represent any means of conveying a voice signal input to the system 120, and a voice signal output. A voice signal may be transmitted as a voltage or a current, an optical signal or an RF signal that is modulated to be able to carry a representation of speech. (The voice signal may or may not actually carry speech. For example, the voice signal may convey silence.) Modulation may be performed in analog or digital form.

For various reasons, any of the paths 140, 150, 160, 170 may initially fail to connect, or may subsequently fail after a connection is formed. If either the transmit path 140 or the receive path 160 fails, but the receive path 150 and the transmit path 170 are formed and maintain continuity, the caller 110 may not have any indication of the failure. Thus, the system 120 may fail to receive an intended voice communication (a message or a voice mail, e.g.), but the caller 110 may believe the message has been recorded.

FIG. 2 illustrates an embodiment of the system 120. The elements of the system 120 may be implemented in hardware, software, or a combination thereof. Hardware may include a microprocessor, finite state machine, storage memory, and signal transducers, e.g. The system 120 includes a voice channel receiver 210 and a voice channel transmitter 220. The receiver 210 is configured to receive a voice signal from the receive path 160. The transmitter 220 is adapted to provide a signal to the transmit path 170.

The receiver 210 provides a signal to a voice activity detector 230 and a recorder 240. The receiver 210 additionally provides an on-hook/off-hook signal for use within the system 120. The recorder 240 and a response synthesizer 250 may use the on-hook/off-hook signal to, e.g., synchronize various activities as described below. The on-hook/off-hook signal reflects the status of the caller 110, where on-hook refers to the state in which the caller 110 is not connected to the system 120, and off-hook refers to the state in which the caller is connected. Such a signal may be conventionally produced, and may be determined, e.g., by the presence of a ring tone or a dial tone on the receive path 160.

The detector 230 is adapted to detect voice activity, e.g., speech, on the signal from the receiver 210. The detector 230 may detect voice activity by analog or digital techniques. In one embodiment, the detector 230 detects an RMS power level of the received signal. In other embodiments, the detector 230 may initially perform an analog-to-digital conversion of the received signal. Digitized data may be subjected to various signal processing algorithms, conventional or novel. Without limitation, known detection algorithms include the G.729 and the GSM standards. In some embodiments, the detector 230 performs a fast Fourier transform (FFT) of sequential frames of digitized data to determine a time-dependent spectral distribution. Various parameters may be calculated from the spectral distribution and compared to parameter values associated with human speech. A signal processing algorithm may include noise subtraction, and may further include feedback to adaptively vary a noise threshold value. Calculated parameters may be compared to a library of parameter values, or known multidimensional response surfaces indicative of the presence of speech.

In some embodiments the detector 230 is implemented using a speech recognition algorithm and/or a data recognition and error correction algorithm, e.g., a hidden Markov model. Some systems may include speech recognition for various purposes. Present embodiments do not rely on speech recognition, though when present for other purposes speech recognition may be used to detect the presence of speech. In such cases, the speech recognition system may be adapted to determine the simple presence of speech.

If the detector 230 detects voice activity, it may signal the recorder 240 to record the output of the receiver 210. In various embodiments, the detector 230 signals the synthesizer 250 that the receive path 160 is off-hook. The synthesizer 250 may generate an initial prompt for transmission on the transmit path 170. The prompt may include, e.g., a greeting, a prompt phrase such as “begin recording”, a tone (the familiar “beep”), or any combination. The system 120 may then record normally and cease recording, e.g., when the caller 110 disconnects and the on-hook/off-hook signal indicates such.

The detector 230 may also signal a response timer 260. The response timer 260 may be configured to time one or more predetermined periods during the operation of the system 120. As described further below, the system 120 is configured to transmit a notice on the path 170 in the event that the detector 230 detects a gap in voice activity after an initial prompt. The timer 260 provides, e.g., timing signals to determine a reference for determine the presence of the gap. A gap may be, e.g., a period of no detectable voice activity. The period may be determined by the timing signals produced by the timer 260. The gap may be period may immediately follow the initial prompt. The gap may also be a period that follows a period of detectable voice activity. In this context, such a gap is sometimes referred to as a “dropout.”

The synthesizer 250 forms audio-frequency signals that are transmitted on the path 170. In various embodiments, the audio signals may be speech utterances, e.g., a notice. A notice may include, e.g., a warning prompt, an error response, a signal tone, or a combination thereof. A signal tone, if produced, may represent the failure of at least one of the transmit paths 140, 160.

The signal tone may be a tone that is distinct from any tones produced by the network 130, such as a dial tone or a ring tone. Such a tone, which may be a sequence of multiple tones, may be defined by an appropriate governing body responsible for defining telecommunications signaling standards, such as the American National Standards Institute (ANSI) or the ITU-T. The tone, or tones, may be configured to be a distinct tone sequence the meaning of which is defined by such standards and reserved for signaling failure of the transmit path 140 or the receive path 160 to a caller 110. In some embodiments the caller 110 is an automated system configured to respond to the signal tone by performing an action.

In some embodiments, the synthesizer 250 provides a signal informing the timer 260 that a prompt or notice is complete. Thus, the timer 260 may begin timing a gap reference period at the end of the prompt or notice. The timer 260 may also signal the synthesizer 250 that a timing period has expired. The synthesizer 250 may then issue a subsequent prompt or notice as determined by a particular embodiment.

The timing period may be adjustable. For example, the system 120 may be configured to allow a user or a system administrator to set a desired period as a reference to determine a gap event. In this way, the sensitivity of the system 120 to gaps may be adjusted to account for operator preference or differences in language cadence. Adjustment may be made, e.g., via a user-selectable switch, software, or remote system administration.

A notice may be any string of utterances suitable to provide aural information to the caller 110. In some cases, a warning prompt may inform the caller 110 that no response has been received. For example, the synthesizer 250 may form a warning prompt similar to, “No message is being received. Please begin speaking now.” In another example, the synthesizer may issue an error response such as “You have failed to leave a message, and no message has been recorded. Goodbye.” Of course, a language other than English may be used when desired. The synthesizer 250 may employ digital speech synthesis, playback of recorded phrases, or assemble stored words or phonemes to form the notice. The synthesizer 250 provides an electrical signal representing the notice to the transmitter 220, which then transmits the notice to the caller 110 via the telephone network 130.

The synthesizer 250 may receive the on-hook/off-hook signal from the receiver 210, and a signal from the detector 230 and base actions thereon. For example, the synthesizer 250 may be configured to terminate a notice if the on-hook/off-hook signal indicates the user 110 has disconnected. Similarly, the synthesizer 250 may terminate a notice when the detector 230 determines that the user 110 has resumed speaking during a gap period.

Turning to FIG. 3 illustrated is a method of the disclosure, generally designated 300. The method 300 is described without limitation with reference to the system 120. The method begins with a step 305, in which a voice communication recorder, e.g., the system 120, accepts a connection from a caller, e.g., the caller 110. In a step 310, the system 120 prompts the caller 110 to leave a message. The prompt may be, e.g., a beep and/or a recorded message. The method 300 may presume that the caller 110 will wait to begin speaking until the conclusion of the prompt. In a decisional step 315, the system 120 enters a listen mode, e.g., to detect speech. The method may include starting a timer during the step 315 to measure a first predetermined period within which speech is expected to begin. The timer is configured to provide a timeout signal upon expiration of the predetermined period.

If speech is detected, the method continues to the step 320, in which a recorder, e.g., the recorder 240, begins recording the received speech. The transition from the step 315 to the step 320 may be conditioned on the non-expiration of the first predetermined period. The method advances to the step 325, in which received signal is tested for the continued presence of speech. The steps 320, 325 form a loop in which normal recording occurs. If no loss of voice signal occurs, the method branches to the step 320 and continues recording. The 320-325 loop continues until the voice signal is lost for a period greater than a predetermined value that may be determined by the timer 260. This period is typically greater than a maximum period expected from, e.g., short gaps in speech such as normal conversational pauses.

In due course, the caller 110 is expected to complete the message and stop speaking. In most cases, the caller 110 disconnects promptly thereafter. When the absence of speech exceeds the predetermined value, the method proceeds to the step 330, in which the voice connection is tested for hang-up. Hang-up may be detected, e.g., by the presence of a dial tone. Typically, a telephone system is configured to produce a dial tone when one caller disconnects after a short delay. If a hang-up is detected, then the method 300 proceeds to a terminating step 335 and disconnects from the transmit path 170.

Returning to the step 315, the system 120 may fail to detect a speech signal following the initial prompt. In this case, the method advances to a step 340, in which a hang-up state is tested. Upon the first invocation of this step, the timer 260 may begin timing a predetermined period. If a hang-up is determined, then the method proceeds to the terminating step 335. If instead the system 120 determines that no hang-up has occurred, the method advances to the step 345. If the predetermined period has not expired, then the method returns to the step 315, where the incoming signal is again tested for the presence of a speech signal. The loop formed by the steps 315-340-345 continues until a hang-up or expiration of the predetermined period, as determined by, e.g., the timer 260.

After the first predetermined period expires, the method advances from the step 345 to the step 350, in which the system 120 generates a notice. This notice may be, e.g., a prompt generated by the synthesizer 250 warning the caller 110 that no message is detected. The method advances to a step 355, in which the system 120 tests the incoming signal for the presence of speech. If the system 120 detects speech, then the method proceeds to the step 320, and recording begins as previously described.

If the system 120 fails to detect speech in the step 355, then the method advances to a step 360, in which the system 120 tests for a hang-up event as described for the step 340. The system 120 may again start a countdown timer on the first occurrence of the step 360 that provides a timeout signal after measuring a second predetermined period. The second predetermined period will in general be different from the first predetermined period. If the system 120 detects a hang-up, the method proceeds to the step 335 and disconnects. If instead the system fails to detect a hang-up, then the method proceeds to a step 365. If the second predetermined period has not expired, then the method branches back to the step 350. The system 120 prompts the caller 110 again, and advances to the step 355. If the system 120 detects a voice signal in the step 355, then the method returns to the step 320 as previously described. If the voice signal is still absent, the method advances again to the step 360.

The method continues executing the loop formed by the steps 350-355-360-365 until either a hang-up is detected in the step 360, or the second predetermined period ends. A timeout may be detected in the step 365. If the second predetermined period expires before a hang-up is detected, the method branches from the step 365 to a step 370. A situation in which the method reaches the step 370 may be, e.g., in which one of the paths 140, 160 was broken before the initial prompt completed in the step 310, or in which one of the paths 140, 160 was never properly formed. In the step 370, the system 120 transmits an error message over the transmit path 170. The error message may be similar to that described earlier. In this manner, the caller 110 is informed that the message, which may contain critical information, was not recorded, and the caller 110 may take appropriate action to ensure such information reaches the intended recipient. The method 300 then proceeds to the step 335 and disconnects.

Returning to the step 330, in some cases the system 120 fails to detect a hang-up, even though the voice signal is lost. In this case, the step 330 branches to loop formed by steps 375-380-385. The operation of this loop is similar to step sequences 315-340-345 and 355-360-365. In the step 375, the system 120 tests for the presence of speech. If speech is detected, as may be the case of a momentary pause or brief disconnection of one of the paths 140, 160, then the method 300 returns to the step 320 and continues recording. The system 120 may optionally pause recording after the voice connection is lost, e.g., at the step 325, or may continue recording throughout the steps 325-330-375-380-385. If the voice signal is not present in the step 375, then the method proceeds to the step 380 and tests for an on-hook condition, e.g., the caller has disconnected. If an on-hook condition is detected, then the method proceeds to the state 335 and disconnects. If instead the system 120 detects an off-hook condition, then a count-down timer, e.g., the timer 260, begins measuring a third predetermined period. This period may be the same or different than the first and second predetermined periods. The method advances to the step 385, in which the system 120 tests for expiration of the third predetermined period. If this period has not expired, then the method returns to the step 375. The loop formed by the steps 375-380-385 continues until the voice signal resumes, a hang-up is detected, or the third predetermined period expires.

If the third predetermined period expires, then the method branches from the step 385 to the step 350. This branch event represents the situation in which, e.g., one of the paths 140, 150 fails while the caller 110 is speaking. As previously described, in the step 350, the system 120 alerts the caller 110 that no message is received. The method continues from the step 350 as previously described.

FIG. 4 illustrates an embodiment of a modification of the method 300, in which a notice may be truncated when the system 120 detects a voice signal during the notice. The illustrated fragment replaces, e.g., the step 350. In a step 410, the synthesizer begins a prompt, e.g., the warning prompt. The method proceeds to a step 420 before the prompt is complete. In the step 420, the system 120 tests for the presence of a speech on the path 160. If speech is present, then the method terminates the prompt in a step 430 and returns to the step 320. If no speech is present in the step 420, then the method branches to a step 440 and tests for completion of the prompt. If the prompt is not complete, the method returns to the step 420. If the prompt is complete, the method advances to the step 360 to test for a hang-up condition.

Those skilled in the pertinent art will recognize that numerous modifications of the method 300 are possible within the scope of the disclosure.

FIG. 5 illustrates an embodiment in which the caller 110 is an automated calling system 500. The system 120 is configured to signal the automated system 500, whereby the automated system 500 may take some action based on the received signal.

The calling system 500 may be configured to be programmed to place telephone calls without intervention after the programming. The calls may be, e.g., advertisements or service provider messages. Examples of provider messages include appointment reminders, test result availability, and financial services events. In many cases, the entity providing the message will presume the message has been received by the recipient. In some cases, the message may contain critical information, and the failure of the system 120 may harm an interest of the intended recipient of the message.

The illustrated embodiment of the calling system 500 includes a controller 510 and a transmitter 520. The controller 510 may direct the transmitter 520 to transmit a voice signal, e.g., a message, over the transmit path 140 associated with the telephone network 130. A receiver 530 is configured to receive a signal from the receive path 150. A tone detector 540 receives an output from the receiver 530 that includes a received transmit path failure tone. The detector 540 signals the controller 510 in response to the failure tone. The failure tone may be, e.g., a signal tone or tone sequence produced by the answering system 120 as described previously. The failure tone is a tone that is distinct from any tones produced by the network 130, such as a dial tone.

Some automated calling systems include a voice detection module that is configured to signal the system to wait until a greeting from an answering system, e.g., the system 120, concludes before delivering the automated message. In some embodiments, the detector 540 is such a detection module that is reconfigured to add the capability to detect the failure tone.

The system 500 may be configured to take an action in response to detecting a failure tone. For example, the controller 510 may direct the transmitter 520 to place the call again. In some cases, the system 500 may alert a human operator that a message was not successfully delivered. This action may be appropriate when the subject matter of the call is of particular importance, such as critical financial or legal information. In other cases, the system 510 may take no action, or may make an entry in a call log.

Those skilled in the art to which this application relates will appreciate that other and further additions, deletions, substitutions and modifications may be made to the described embodiments.

What is claimed is:

1. A telephone answering system, comprising:
a receiver configured to receive a voice signal;
a detector adapted to detect voice activity on said signal; and
a transmitter adapted to transmit an initial prompt, and in the event that said detector detects a gap in said detected voice activity after said initial prompt, to transmit a notice.

2. The system as recited in claim 1, wherein said gap is a period of no detectable voice activity that begins after a period of detectable voice activity.

3. The system as recited in claim 1, wherein said notice includes a warning prompt and an error response.

4. The system as recited in claim 3, wherein said transmitter is further configured to transmit said error response in the event that said detector fails to detect voice activity during a predetermined period after said warning prompt.

5. The system as recited in claim 1, wherein said notice includes at least one transmit path failure tone.

6. The system as recited in claim 5, wherein said at least one transmit path failure tone is configured to signal an automated calling system.

7. The system as recited in claim 1, wherein said detector detects voice activity by determining an RMS power of said voice signal.

8. The system as recited in claim 1, wherein said detector detects voice activity by analyzing a spectrum of said voice signal.

9. The system as recited in claim 1, wherein said transmitter is configured to terminate said notice in the event that said detector detects voice activity during said notice.

10. The system as recited in claim 1, wherein said receiver is coupled to a wireless telephone system or the internet.

11. A method of telephone communication, comprising:
transmitting an initial prompt;
determining if voice activity is present on a voice channel; and
transmitting a notice in the event that said determining detects a gap in said voice activity after said initial prompt.

12. The method as recited in claim 11, wherein said gap is a period of no detectable voice activity that begins after a period of detectable voice activity.

13. The method as recited in claim 11, wherein said notice includes a warning prompt and an error response.

14. The method as recited in claim 13, further comprising transmitting said error response in the event that said determining fails to detect voice activity during a predetermined period after said warning prompt.

15. The method as recited in claim 11, wherein said notice includes at least one transmit path failure tone.

16. The method as recited in claim 14, wherein said at least one tone is configured to signal an automated calling system.

17. The method as recited in claim 11, wherein said determining includes determining an RMS power of said voice signal.

18. The method as recited in claim 11, wherein said determining includes spectral analysis of said voice signal.

19. The method as recited in claim 11, wherein said transmitting includes terminating said notice in the event that voice activity is detected during said notice.

20. The method as recited in claim 11, wherein said receiving includes receiving said voice signal from a wireless telephone system or the internet.

21. A calling system, comprising:
a controller configured to place a telephone call;
a receiver configured to receive a transmit path failure tone in response to said call; and
a tone detector configured to provide an alert in response to said tone.

22. The system as recited in claim 21, wherein said controller informs an operator in response to said alert.

23. The system as recited in claim 21, wherein said tone detector is a voice detection module also configured to detect said tone.
